(19) United States
(12) Patent Application Publication
(10) Pub. No.: US 2007/0043134 A1
(43) Pub. Date: Feb. 22, 2007

(54) Polymerisation initiators

(76) Inventor: Vernon Charles Gibson, London (GB)

Correspondence Address: Scott A McCollister;Fay Sharpe Fagan Minnich & McKee, 1100 Superior Avenue, 7th Floor, Cleveland, OH, 44114-2518, US

(21) Appl. No.: 10/548,889

(22) PCT Filed: Mar. 12, 2004
(86) PCT No.: PCT/GB04/01078

§ 371 Date: Sep. 28, 2006

(30) Foreign Application Priority Data
Mar. 31, 2003 (GB) 0305817.9

(51) Int. Cl. C08F 2/50

(52) U.S. Cl. 522/6

(57) ABSTRACT

The present invention relates to the use of a compound of formula (I): (L)ₐ(M¹)_{b}(M²)_{c}(X)ₙ as a polymerisation initiator, wherein M¹ is a metal of Group 1, Group 2 or Group 12; M² is transition metal or a main group metal, and M¹≠M²; each of b and c is independently 1 or 2; each X is independently selected from alkoxide (OR¹), thiolate (SR²), amide (NR ³R⁴), carboxylate (C0₂R⁵) and acetylacetonate (HC(C(O)R⁶)₂); each of R¹⁻⁶ is independently a hydrocarbyl group; n is an integer such that the compound has an overall charge of zero; and L is absent or is a neutral donor ligand, where a is 1, 2, 3 or 4. The invention further relates to a novel compound of formula (I), and compositions comprising compounds of formula (I).

The present invention relates to the use of ionic metal complexes as polymerisation initiators. More specifically, but not exclusively, the invention relates to the use of ionic metal complexes as initiators in the polymerisation of epoxides and/or lactones.

### BACKGROUND TO THE INVENTION

Over recent years, the increasing need to find alternative polymeric materials to those based on non-renewable petroleum resources, along with the desire to produce environmentally benign biodegradable plastics, has led to great interest in the ring-opening polymerisation of cyclic esters such as lactide, LA (R. E. Drumright, P. R. Gruber and D. E. Henton, Adv. Mater., 2000, 12, 1841) and ε-caprolactone.

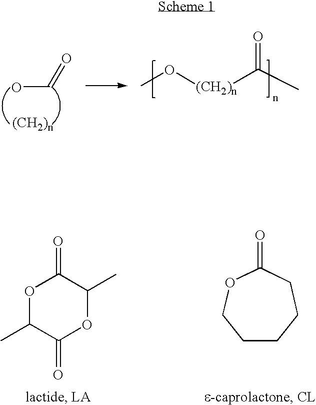

Lactide, a cyclic diester derived from lactic acid, is readily obtained from renewable resources such as corn starch, sugar and dairy products, and as such there is great potential for developing new materials from these biosustainable resources. Interest in polyesters also stems from their uses for in vivo medical applications, such as bioresorbable sutures, implantation devices (J. C. Middleton and A. J. Tipton, Biomaterials, 2000, 21, 2335) and drug delivery agents (K. Uhrich, S. M. Cannizzaro, R. S. Langer, K. M. Shakesheff, Chem. Rev., 1999, 99, 3181).

To date, the ring opening polymerisation of lactide is usually initiated by alkoxide complexes of metals such as Al (D. Tian, Ph. Dubois, R. Jérôme and Ph. Teyssié, Macromolecules 1997, 30, 2575; S. Inoue, J. Polym. Sci., Polym. Chem. 2000, 38, 2861; A. Kowalsid, A. Duda, and S. Penczek, Macromolecules 1998, 31, 2114), Mg (M. H. Chisholm, N. W. Eilerts, J. C. Huffinan, S. S. Iyer, M. Pacold and K. Phomphrai, J. Am. Chem. Soc. 2000, 122, 11845), Zn (B. M. Chamberlain, M. Cheng, D. R. Moore, T. M. Ovitt, E. B. Lobkovsky, and G. W. Coates, J. Am. Chem. Soc. 2001, 123, 3229), Sn (A. P. Dove, V. C. Gibson, E. L. Marshall, A. J. P. White and D. J. Williams, Chem. Commun. 2001, 283; A. P. Dove, V. C. Gibson, E. L. Marshall, WO 0238574, 2002) and also the rare earth metals (S. J. McLain, and N. E. Drysdale, U.S. Pat. No. 5,028,667, 1991; W. M. Stevels, M. J. K. Ankoné, P. J. Dijkstra and J. Feijen, Macromolecules 1996, 29, 3332). Complete removal of the metal from the product is typically troublesome, leading to contamination of the polymer with catalyst residues. Clearly, when the polymer is intended for biomedical or food packaging applications, the use of initiators based on toxic metals is undesirable, and there is therefore considerable interest in designing initiators based on low-toxicity metals for the controlled polymerisation of cyclic esters.

In this respect, iron complexes are attractive as potential catalysts for this reaction due to the general low bio-toxicity of iron. There have been a number of reports of iron being used, for example iron porphyrins (H. R. Kricheldorf, H. R. and C. Boettcher, Makromol. Chem. 1993, 194, 463) and iron acetate (M. Stolt and A. Södergard, Macromolecules 1999, 32, 6412). However, polymerisations with these compounds were slow despite high temperatures being employed. More recently, Tolman et al reported that homoleptic Fe(III) complexes act as efficient initiators for the controlled polymerisation of ε-caprolactone, CL, and lactide (O'Keefe, B. J.; Monnier, S. M.; Hillmyer, M. A.; Tolman, W. B. J. Am. Chem. Soc. 2001, 123, 339; O'Keefe, B. J.; Monnier, S. M.; Hillmyer, M. A.; Tolman, W. B. J. Am. Chem. Soc. 2001, 123, 339). Bimetallic alkoxides of the general formula Zn(OAl(OR)₂)₂ have also been shown to initiate the ROP of ε-caprolactone (Hamitou, A., Jérôme, R., Hubert, A. J., Teyssié, Ph. Macromolecules 1973, 6, 651; Ouhadi, T., Bioul, J. P., Stevens, R., Hocks, W. L., Teyssié, Ph. Inorg. Chim. Acta. 1976, 19, 203) and lactide (Song, C. X., Feng, X. D. Macromolecules 1984, 17, 2764).

Polyethers are another commercially important class of polymers. Polyethers are produced via the ring-opening polymerisation (ROP) of epoxides (Scheme 2) and are especially important as precursors to polyurethanes (Scheme 3) (K. Owens and V. L. Kyllingstad, Kirk-Othmer Encyclopaedia of Chemical Technology, 4^{th} Edition, 1993, 1079; D. M. Back, E. M. Clark, and R. Ramachandran, Kirk-Othmer Encyclopaedia of Chemical Technology, 4^{th} Edition, 1993, 701; S. D. Gagnon, Kirk-Othmer Encyclopaedia of Chemical Technology, 4^{th} Edition, 1993, 722).

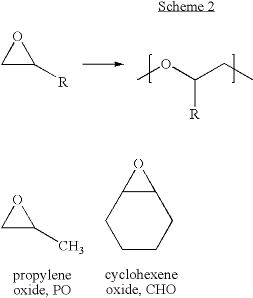

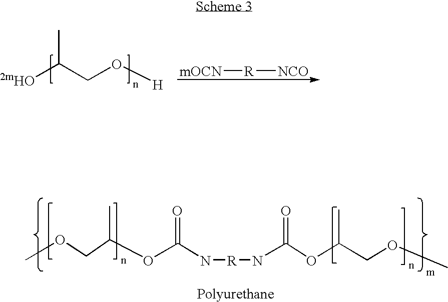

Although a wide variety of reagents can affect the cationic or anionic ROP of epoxides, low molecular weight polyols are generally prepared using potassium hydroxide or sodium hydroxide. To date, higher molecular weight materials are typically prepared using coordination catalysts, such as the calcium amide-alkoxide system developed by Union Carbide, (G. L. Goeke, and F. J. Karol, U.S. Pat. No. 4,193,892, 1980) and double metal cyanide (DMC) initiators, e.g. [Zn(Fe(CN)₆)] (B. Le-Khac, U.S. Pat. No. 5,482,908, 1996). The nature of the active sites in these catalysts is not well understood and only a few studies have been published in the literature, (see for example V. J. Huang, G. R. Qi and Y. H. Wang, J. Polym. Sci., Polym. Chem. 2002, 40, 1142; B. Antelmann, M. H. Chisholn., S. S. Iyer, J. C. Huffinan, D. Navarro-LLobet, W. J. Simonsick and W. Zhong, Macromolecules 2001, 34, 3159).

The present invention seeks to provide improved polymerisation initiators which alleviate one or more of the problems associated with prior art initiators. Specifically, the invention aims to provide well-defined polymerisation initiators that are low in toxicity and/or which enable the properties of the resulting polymer to be fine-tuned. More particularly, the invention seeks to provide polymerisation initiators that lead to the production of high molecular weight polymers under mild conditions.

### STATEMENT OF INVENTION

In a first aspect, the invention relates to the use of a compound of formula I
(L)ₐ(M¹)_{b}(M²)_{c}(X)ₙ I
as a polymerisation initiator, wherein
M₁ is a metal of Group 1, Group 2 or Group 12;
M² is transition metal or a main group metal, and M¹≠M²;
each of b and c is independently 1 or 2;
each X is independently selected from alkoxide (OR¹), thiolate (SR²), amide (NR³R⁴), carboxylate (CO₂R⁵) and acetylacetonate (HC(C(O)R⁶)₂);
each of R¹⁻⁶ is independently a hydrocarbyl group;
n is an integer such that the compound has an overall charge of zero; and
L is absent or is a neutral donor ligand, where a is 1, 2, 3 or 4.

A second aspect of the invention relates to a composition comprising a compound of formula I as defined above, an epoxide, and methyl aluminium bis(2,6-di-tert-butyl-4-methylphenoxide).

A third aspect of the invention relates to a composition comprising a compound of formula I as defined above, and a lactone.

A fourth aspect of the invention relates to a process for polymerising an epoxide, said method comprising contacting an epoxide with (i) a compound of formula I as defined above; and (ii) methyl aluminium bis(2,6-di-tert-butyl-4-methylphenoxide), optionally in the presence of a solvent.

A fifth aspect of the invention relates to a process for polymerising a lactone, said method comprising contacting a lactone with a compound of formula I as defined above, optionally in the presence of a solvent.

A sixth aspect of the invention relates to a polymer obtainable by a process as defined above.

A seventh aspect of the invention relates to compounds of the formula [(THF)₄Na₂Fe(OAr)₄], where Ar is an aryl group.

An eighth aspect of the invention relates to a process for preparing compounds of formula [(THF)₄Na₂Fe(OAr)₄].

### DETAILED DESCRIPTION

The present invention relates to the use of mixed metal complexes of formula I as defined above as polymerisation initiators.

As used herein, the term “polymerisation initiator” refers to an agent used to start the polymerisation of a monomer.

As used herein, the term “main group metal” refers to a metal of Group 1, 2, 13, 14, 15 or 16 of the periodic table. By way of example, this includes Li, Na, K, Rb, Cs (Group 1), Be, Mg, Sr, Ba (Group 2), Al, Ga, In, Tl (Group 13), Sn, Pb (Group 14), Bi (Group 15), Po (Group 16).

As used herein, the term “transition metal” refers to a metal of any one of Groups 3 to 12 of the periodic table.

As used herein, the term “hydrocarbyl” refers to a group comprising at least C and H that may optionally comprise one or more other suitable substituents. Examples of such substituents may include halo-, alkoxy-, nitro-, an alkyl group, or a cyclic group. In addition to the possibility of the substituents being a cyclic group, a combination of substituents may form a cyclic group. If the hydrocarbyl group comprises more than one C then those carbons need not necessarily be linked to each other. For example, at least two of the carbons may be linked via a suitable element or group. Thus, the hydrocarbyl group may contain heteroatoms. Suitable heteroatoms will be apparent to those skilled in the art and include, for instance, sulphur, nitrogen, oxygen, phosphorus and silicon.

As used herein, the term “aryl” refers to an aromatic group which may be substituted (mono- or poly-) or unsubstituted, fused or unfused. Suitable substituents include halo-, alkoxy-, nitro-, an alkyl group, or a cyclic group.

As used herein, the term “heteroaromatic group” refers to an aromatic heterocycle comprising one or more heteroatoms. Preferred heteroaryl groups include pyrrole, pyrimidine, pyrazine, pyridine, quinoline and furan.

In one preferred embodiment of the invention, each X is independently alkoxide (OR¹) or carboxylate (CO₂R⁵).

Preferably, each R¹⁻⁶ is independently a C₁-C₂₀ alky, a C₂-C₂₀ alkene, a C₆-C₂₀ aryl or a C₂-C₂₀ heteroaromatic group.

Even more preferably, each of R¹⁻⁶ is independently Et, ^{t}Bu, ⁱPr or 2,6-di-iso-propylphenyl.

One particularly preferred embodiment relates to the use of a compound of the formula (L)ₐ(M¹)_{b}(M²)_{c}(OR¹)ₙ.

In one preferred embodiment, n is 3, 4, 5 or 6.

In one particularly preferred embodiment, each OR¹ is independently OEt, O^{t}Bu, OⁱPr or O-(2,6-di-iso-propylphenyl).

The synthesis of mixed metal alkoxide complexes used in the present invention is well documented in the art. For example, various MₓM′_{y}(OR)_{z} compounds (M=Li, Na, K; M′=Zr, Ti; R=Me, ⁱPr, ^{t}Bu) were reported by Mehrotra and Agrawal (R. C. Mehrotra and M. M. Agrawal, J. Chem. Soc (A) 1967, 1026). The syntheses of M[Ti(O¹Pr)₅] (M=Li, Na, K) (M. J. Hampden-Smith, D. S. Williams and A. L. Rheingold, Inorg. Chem. 1990, 29, 4076; T. J. Boyle, D. C. Bradley, M. J. Hampden-Smith, A. Patil and J. W. Ziller, Inorg. Chem. 1995, 34, 5893) and Na[M(OEt)₆] (M=Nb, Ta) (R. C. Mehrotra, M. M. Agrawal and P. N. Kapoor, J. Chem. Soc. (A), 1968, 2673; R. C. Mehrotra, Advances in Inorganic Chemistry and Radiochemistiy, 1983, 26, 269; D. J. Eichorst, K. E. Howard, D. A. Payne and S. R. Wilson, Inorg. Chem., 1990, 29, 1458) have also been described. The synthesis of {[Na(THF)]⁺[Fe(O^{t}Bu)₃]⁻}₂ has also been reported recently (Y. K. Gun'ko, U. Cristmann and V. G. Kelssler, Eur. J. Inorg. Chem. 2002, 1029). However, to date there has been no suggestion that the above-described mixed metal complexes would be useful as polymerisation initiators. Moreover, there is no teaching in the prior art to suggest that such complexes would be suitable for initiating the polymerisation of lactide and/or epoxides.

Another particularly preferred embodiment relates to the use of a compound of the formula (L)ₐ(M¹)_{b}(M²)_{c}(OR¹)_{q}(CO₂R⁵)ᵣ, wherein q and r are integers such that the compound has an overall charge of zero.

Preferably, (q+r) is 3, 4, 5 or 6.

In one preferred embodiment of the invention, b and c are both 1.

In another preferred embodiment of the invention, b is 2 and c is 1.

Preferably, the neutral donor ligand, L, is THF, Et₂O, CH₃CN, pyridine or a crown ether.

Preferably, the neutral donor ligand is bound to M¹.

In one highly preferred embodiment, the neutral donor ligand is THF. Preferably, M¹ is a group 1 metal.

Even more preferably, M¹ is Na, Li or K.

Preferably, M² is a metal selected from group 4, 5, 12 or 13.

Even more preferably, M² is Nb, Ti, Al, Ta or Fe.

In one especially preferred embodiment of the invention, the compound of formula I is selected from the following:
{[Na(THF)]⁺[Fe(O^{t}Bu)₃]⁻}₂;
([Na(THF)₂]⁺)₂[Fe(OAr)₄]²⁺ where Ar is 2,6-di-iso-propylphenyl;
Na⁺[Ta(OEt)₆]⁻;
Na⁺[Nb(OEt)₆]⁻;
Li⁺[Ti(OⁱPr)₅]⁻;
Na⁺[Ti(OEt)₅]⁻;
Li⁺[Ti(OEt)₅]⁻; and
K⁺[Al(OEt)₄]⁻.
   Epoxide Polymerisation

In one preferred embodiment, the invention relates to the use of compounds of formula I as initiators in the polymerisation of epoxides.

As already mentioned, polyethers produced by the ring-opening polymerisation of epoxides are of commercial importance, particularly as precursors to polyurethanes.

One aspect of the invention relates to the use of a compound of formula I as an initiator for the polymerisation of an epoxide, wherein said compound of formula I is used in combination with methyl aluminium bis(2,6-di-tert-butyl-4-methylphenoxide), the structure of which is shown below.

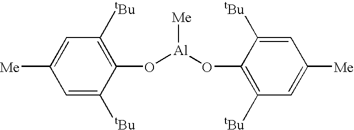

Preferably, for this aspect of the invention,
M¹ is a metal of Group 1;
M² is selected from Nb, Ta, Ti and Al;
each X is independently an alkoxide (OR¹); and
L is absent.

Even more preferably, for this aspect of the invention,
M¹ is selected from Na, K and Li;
M² is selected from Nb, Ta, Ti and Al;
each X is independently selected from OEt, OⁱPr and O^{t}Bu; and
L is absent.

More preferably still, for this aspect of the invention, said compound of formula I is selected from the following:
Na⁺[Ta(OEt)₆]⁻;
Na⁺[Nb(OEt)₆]⁻;
Li⁺[Ti(OⁱPr)⁵]⁻;
Na⁺[Ti(OEt)₅]⁻;
Li⁺[Ti(OEt)₅]⁻; and
K⁺[Al(OEt)₄]⁻.

The epoxides used in the context of the present invention include any epoxide, including functionalised epoxides, i.e., epoxides with a side-chain containing other functional groups, for example, one or more ether, ester, amine, amide, halide, carboxylic acid, acid chloride, alcohol, groups or one or more unsaturated C═C bonds. The epoxide group may also form part of, or be bound to, a more complex molecule, for example, a peptide, drug or nucleotide base.

In one particularly preferred embodiment of the invention, the epoxide is selected from the following:

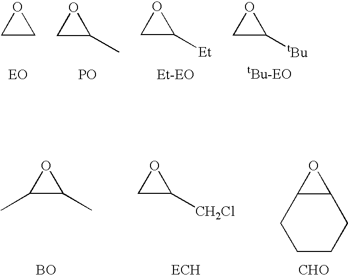

In one particularly preferred embodiment of the invention, the epoxide is propylene oxide (PO) or cyclohexene oxide (CHO).

Preferably, the polymerisation process takes place at room temperature.

In one highly preferred embodiment of the invention, the compound of formula I is Na⁺[Ta(OEt)₆]⁻ or Na⁺[Nb(OEt)₆]⁻. These compounds are particularly effective as initiators in the production of high molecular weight polymers derived from PO.

In one preferred embodiment, the ratio of the compound of formula I to MAD is in the range of 1 to 1000:1, and more preferably in the range of 1 to 100:1, more preferably still 1 to 10:1.

In one preferred embodiment, the ratio of epoxide to the compound of formula I is in the range of 1 to 1 000 000:1.

Lactone Polymerisation

In another preferred embodiment, the invention relates to the use of compounds of formula I as initiators in the polymerisation of lactones.

Preferably, for this aspect of the invention,
M¹ is a metal of Group 1;
M² is transition metal;
each X is independently an alkoxide (OR¹); and
L is THF.

Even more preferably, for this aspect of the invention, said compound of formula I is {[Na(THF)]⁺[Fe(O^{t}Bu)₃]⁻}₂ or ([Na(THF)₂]⁺)₂[Fe(OAr)₄]²⁺ where Ar is ^{2,6}-di-iso-propylphenyl.

In one particularly preferred embodiment of the invention, the lactone is lactide or ε-caprolactone. The term “lactide” encompasses rac-lactide, meso-lactide and the resolved L and D forms of lactide.

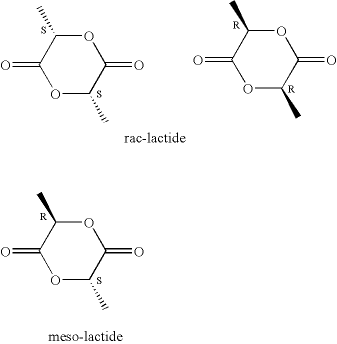

As used herein, the term “rac-lactide” refers to a racemic mixture of L (S,S) and D (R,R) lactide.

Preferably, the polymerisation process takes place at a temperature of from room temperature to about 60° C.

In one particularly preferred embodiment of the invention, the polymerisation process takes place in the presence of an alcohol, preferably ethanol. More preferably, the polymerisation takes place in the presence of 1-3 equivalents of ethanol. Advantageously, the addition of ethanol leads to a lowering of Mₙ, together with an increase in the polydispersity index, M_{w}/Mₙ, thereby suggesting that the added alcohol promotes chain transfer.

In another preferred embodiment of the invention, the polymerisation process takes place in the presence of a carboxylic acid, for example, benzoic acid. The addition of 1 equivalent of benzoic acid has been shown to slow the polymerisation of lactide and leads to an increase in the polymer molecular weight for a given lactide to initiator ratio.

In one preferred embodiment, the ratio of lactone to the compound of formula I is in the range of 1 to 10,000:1, and more preferably in the range of 1 to 500:1.

Compounds

A further aspect of the present invention relates to compounds of formula [(THF)₄Na₂Fe(OAr)₄], where Ar is an aryl group.

In one especially preferred embodiment, Ar is 2,6-di-iso-propylphenyl.

One particularly preferred embodiment relates to the compound [(THF)₄Na₂Fe(OAr)₄], where Ar is 2,6-di-iso-propylphenyl, in crystalline form.

Another aspect of the invention relates to a process for preparing a compound of the formula [(THF)₄Na₂Fe(OAr)₄], said process comprising:

(i) reacting ArOH with sodium metal in the presence of THF;

(ii) contacting the product of step (i) with FeBr₃ in THF;

(iii) optionally crystallising the product of step (ii).

In one preferred embodiment, ArOH is 2,6-di-iso-propylphenol.

The invention is further described by way of example and with reference to the following figures wherein:

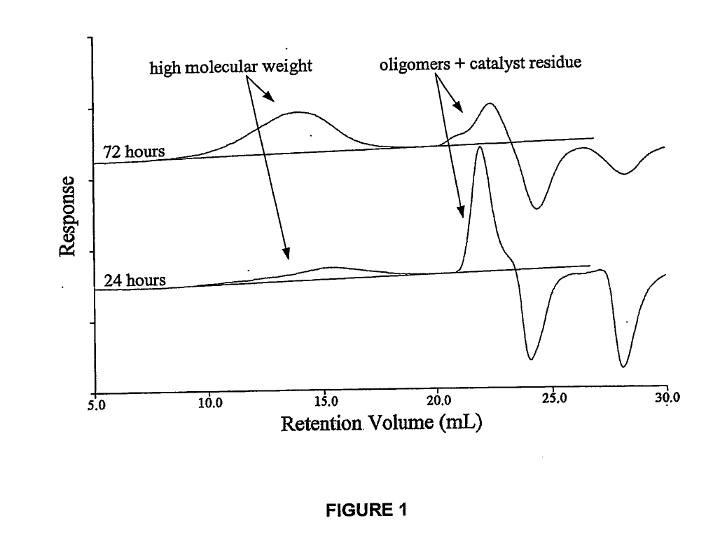

FIG. 1 shows gel permeation chromatography (GPC) traces for entries 5 and 6 in Table 1.

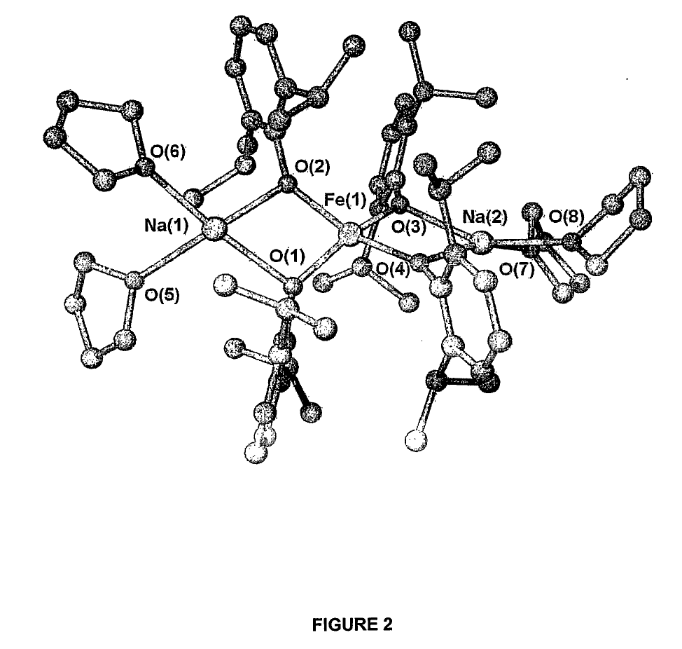

FIG. 2 shows the crystal structure of the complex (THF)₄Na₂Fe(OAr)₄.

### EXAMPLES

Compounds of the formula MₓM_{y}(OR)_{z} (M=Li, Na, K; M′=Zr, Ti; R=Me, ⁱPr, ^{t}Bu) were prepared by the methods described in R. C. Mehrotra and M. M. Agrawal, J. Chem. Soc (A) 1967, 1026.

{[Na(THF)]⁺[Fe(O^{t}Bu)₃]⁻}₂ was prepared in accordance with Y. K. Gun'ko, U. Cristmann and V. G. Kelssler, Eur. J. Inorg. Chem. 2002, 1029.

Na⁺[Ta(OEt)₆]⁻ and Na⁺[Nb(OEt)₆]⁻ were prepared in accordance with R. C. Mehrotra, M. M. Agrawal and P. N. Kapoor, J. Chem. Soc. (A), 1968, 2673; R. C. Mehrotra, Advances in Inorganic Chemistry and Radiochemistry, 1983, 26, 269; D. J. Eichorst, K. E. Howard, D. A. Payne and S. R. Wilson, Inorg. Chem., 1990, 29, 1458.

Li⁺[Ti(OⁱPr)₅]⁻ and Na⁺[Ti(OEt)₅]⁻ were prepared in accordance with M. J. Hampden-Smith, D. S. Williams and A. L. Rheingold, Inorg. Chem. 1990, 29, 4076; T. J. Boyle, D. C. Bradley, M. J. Hampden-Smith, A. Patil and J. W. Ziller, Inorg. Chem. 1995, 34, 5893

Synthesis of [(THF)₄Na₂Fe(OAr)₄]

To a solution of 2,6-diisopropylphenol (4.69 g, 26.3 mmol) in 15 mL of THF was added sodium metal (0.670 g, 29.1 mmol) and the solution was left to stir overnight. Excess sodium was removed and the solution was then added to a suspension of FeBr₂ (1.86 g, 8.62 mmol) in 30 mL of THF at 0° C. After stirring for 2 days at ambient temperature the solution was filtered, reduced to ca 10 mL and 15 mL of pentane added. The product was crystallised at −30° C., the mother liquor filtered off, and the product washed with pentane (−30° C.) until the washings were colourless. Drying in vacuo afforded grey-green microcrystals. Yield: 3.572 g (49%). ¹H NMR (250 MHz, THF-d₈) δ: 1.1 (br, (H₃C)₂CH); 3.6, 1.7 (THF-H); 7 (br, PhH). Anal. Calcd. for C₆₄H₁₀₀O₈FeNa₂ (found): C, 69.93 (70.92); H, 9.17 (8.59).

Epoxide Polymerisation

The use of compounds of general formula I as polymerisation of epoxides was investigated. The results of these studies are summarised below in Table 1.

TABLE 1

| | | Cocatalyst | Monomer | | | | |
|---|---|---|---|---|---|---|---|
| Entry | Catalyst | (equiv.) | (equiv.) | Conditions | Yield | Mₙ^{a} | M_{w}/Mₙ^{a} |
| 1 | Na⁺[Nb(OEt)₆]⁻ | | PO (200) | toluene, 25° C., | 0% | — | — |
| | | | | 24 h | | | |
| 2 | Na⁺[Nb(OEt)₆]⁻ | MAD (3) | PO (200) | toluene, 25° C., | 50% | oligomers + 1,139,000^{b} | −5.30 |
| | | | | 72 h | | | |
| 3 | Na⁺[Nb(OEt)₆]⁻ | MAD (3) | PO (200) | neat, 25° C., 24 h | 88% | oligomers + 208,400^{b} | −4.71 |
| 4 | Na⁺[Ta(OEt)₆]⁻ | | PO (200) | toluene, 25° C., | 0% | — | — |
| | | | | 24 h | | | |
| 5 | Na⁺[Ta(OEt)₆]⁻ | MAD (3) | PO (200) | toluene, 25° C., | 85% | oligomers + 321,000^{b} | −3.45 |
| | | | | 24 h | | | |
| 6 | Na⁺[Ta(OEt)₆]⁻ | MAD (3) | PO (200) | toluene, 25° C., | 96% | oligomers + 677,000^{b} | −10.89 |
| | | | | 72 h | | | |
| 7 | Li⁺[Ti(OⁱPr)₅]⁻ | MAD (3) | PO (400) | toluene, 25° C., | 3% | — | — |
| | | | | 24 h | | | |
| 8 | Na⁺[Ti(OEt)₅]⁻ | MAD (3) | PO (400) | toluene, 25° C., | 15% | 860 | — |
| | | | | 24 h | | | |
| 9 | Li⁺[Ti(OⁱPr)₅]⁻ | MAD (3) | PO (400) | neat, 25° C., 24 h | 25% | 1,190 | 1.25 |
| 10 | Li⁺[Ti(OEt)₅]⁻ | MAD (3) | PO (400) | THF, 25° C., 96 h | 10% | oligomers^{b} | — |
| 11 | Li⁺[Ti(OEt)₅]⁻ | MAD (3) | PO (400) | neat, 25° C., 24 h | 18% | 880 | — |
| 12 | K⁺[Al(OEt₄)]⁻ | MAD (3) | PO (400) | THF, 25° C., 96 h | 20% | 860 | — |
| 13 | K⁺[Al(OEt₄)]⁻ | MAD (3) | PO (400) | neat, 25° C., 24 h | 50% | 3,200 | 1.16 |
| 14 | Na⁺[Ti(OEt)₅]⁻ | MAD (3) | CHO (200) | THF, 25° C., 24 h | 100% | 5,030 | 1.22 |
| 15 | Na⁺[Ti(OEt)₅]⁻ | MAD (3) | CHO (200) | neat, 25° C., 24 h | 100% | 12,900 | 2.65 |
| 16 | K⁺[Al(OEt₄)]⁻ | MAD (3) | CHO (200) | THF, 25° C., 24 h | 100% | oligomers + 5,870^{b} | −1.25 |
| 17 | K⁺[Al(OEt₄)]⁻ | MAD (3) | CHO (200) | neat, 25° C., 24 h | 100% | oligomers + 9.990^{b} | −2.29 |
| 18 | K⁺[Al(OEt₄)]⁻ | MAD (3) | CHO (200) | neat, 25° C., 7 h | 75% | 15,200 | 2.60 |
| 19 | K⁺[Al(OEt₄)]⁻ | MAD (1) | CHO (200) | neat, 25° C., 7 h | 69% | 18,300 | 2.20 |
| 20 | K⁺[Al(OEt₄)]⁻ | MAD | CHO (200) | neat, 25° C., | 15% | 8,460 | 2.07 |
| | | (0.5) | | 120 h | | | |
| 21 | K⁺[Al(OEt₄)]⁻ | MAD | CHO (200) | neat, 25° C., | 11% | 11,600 | 1.88 |
| | | (0.25) | | 120 h | | | |

^{a}Determined by gel permeation chromatography, GPC;
^{b}Molecular weight of oligomers below GPC calibration curve (i.e. <500 Da).

Initial studies with Na[Nb(OEt)₆] and Na[Ta(OEt)₆] (entries 1 and 4) revealed that the complexes were inactive for the ROP of PO. However, the addition of 3 equivalents of MAD (MAD=methyl aluminium bis(2,6-di-tert-butyl-4-methylphenoxide), generated active initiator systems (entries 2, 3 and 5, 6). In a control experiment it was found that MAD in the absence of Na[Nb(OEt)₆] and Na[Ta(OEt)₆] brings about only a very low conversion of PO. It appears that the tantalate complex is more active than its niobium counterpart (e.g. compare the yields with entries 2 and 5, recorded over 72 and 24 h respectively). A noteworthy feature of both these initiator systems is that the poly(propylene oxide), PPO, produced is bimodal, with a substantial amount of high molecular weight material, as shown by gel permeation chromatography (FIG. 1). The proportion of high molecular PPO increases with the reaction time.

The choice of metal in the anionic component of the initiator appears to be crucial, as further studies with titanium and aluminium alkoxide anions resulted in much lower molecular weight PPO (entries 9-13).

Poly(cyclohexene oxide), PCHO, may also be prepared using these initiators. CHO readily ring-opens (a consequence of its greater ring strain relative to PO), and high conversions to polymer are therefore typical (entries 14-21).

By way of summary, a variety of the bimetallic complexes described herein have been shown to initiate the ROP of epoxides in the presence of MAD. The most notable results are obtained using Na[M(OEt)₆] (M=Nb, Ta) which are particularly effective initiators for the production of high molecular weight PO.

Lactone Polymerisation

{[Na(THF)]⁺[Fe(O^{t}Bu)₃]⁻}₂ (Gun'ko, Y. K.; Cristmann, U.; Kelssler, V. G. Eur. J. Inorg. Chem. 2002, 1029) and ([Na(THF)₂]⁺)₂[Fe(OAr)₄]²⁺, prepared from the reaction of Na(OAr) with FeBr₂ (3:1 stoichiometry) in THF (see experimental), were investigated as initiators for the polymerisation of lactide (Ar=2,6-di-iso-propylphenyl). The results are summarised in Table 2.

Both complexes rapidly polymerise lactide at ambient temperature. For instance, within two hours complete conversion of 230 equivalents of lactide (relative to Fe) is achieved with {[Na(THF)]⁺[Fe(O^{t}Bu)₃]⁻}₂ (entry 1). ([Na(THF)₂]⁺)₂[Fe(OAr)₄]²⁺ is also very efficient (entries 10-13). Increased activity is observed at 60° C. For instance, {[Na(THF)]⁺[Fe(O^{t}Bu)₃]⁻}₂ polymerises 370 equivalents of lactide in 30 minutes (entry 14). Analysis of the (proton decoupled) methine region in the ¹H NMR spectrum of a sample of polymer resulting from {[Na(THF)]⁺[Fe(O^{t}Bu)₃]⁻}₂ showed the structure of the polymer to be atactic.

In a number of runs the effect of added ethanol (1-3 equivalents) was investigated. Increasing the amount of ethanol leads to a lowering of the Mₙ along with an increase in the polydispersity index (M_{w}/Mₙ). The lower values of Mₙ together with higher M_{w}/Mₙ values suggest the added alcohol promotes chain transfer, as might be expected. ¹H NMR end group analysis of the poly(lactide), which clearly shows ethoxy ester end groups when ethanol is added to the runs, suggests that the bulky alcoholate ligands of {[Na(THF)]⁺[Fe(O^{t}Bu)₃]⁻}₂ and ([Na(THF)₂]⁺)₂[Fe(OAr)₄]²⁺ are replaced with the ethoxide group. The effect of added benzoic acid was also investigated, and was found to have the opposite effect to that of ethanol. One equivalent of benzoic acid both slowed the polymerisation of lactide and led to an increase in the polymer molecular weight for a given lactide to initiator ratio. For instance, with a lactide:initiator ratio of 200 the conversion reaches only 57% after 3 hours (entry 7). After 5 hours 72% conversion is reached, with an Mₙ of 43685 (entry 8). The likely reason behind these effects is coordination of the benzoate group with displacement of an alkoxide group. The benzoate ligand would be a poor initiator of polymerisation, thus a reduced number of initiating alkoxide sites would lead to slower polymerisation and higher molecular weights as a result of a lower number of growing polymer chains per Fe centre.

TABLE 2

| | | | Time | Conversion | | |
|---|---|---|---|---|---|---|
| Entry | Catalyst | [LA]₀/[Fe]₀ | (min) | (%) | Mₙ | M_{w}/Mₙ |
| 1 | [(THF)NaFe(O^{t}Bu)₃]₂ | 230 | 120 | 99 | 21400 | 1.57 |
| 2 | [(THF)NaFe(O^{t}Bu)₃]₂ | 420 | 180 | 93 | 34400 | 1.43 |
| 3 | [(THF)NaFe(O^{t}Bu)₃]₂^{b} | 220 | 120 | 98 | 16800 | 1.72 |
| 4 | [(THF)NaFe(O^{t}Bu)₃]₂^{b} | 390 | 180 | 96 | 23300 | 1.58 |
| 5 | [(THF)NaFe(O^{t}Bu)₃]₂^{c} | 380 | 180 | 98 | 20800 | 1.67 |
| 6 | [(THF)NaFe(O^{t}Bu)₃]₂^{d} | 380 | 180 | 99 | 13900 | 2.07 |
| 7 | [(THF)NaFe(O^{t}Bu)₃]₂^{e} | 210 | 180 | 57 | 28256 | 1.19 |
| 8 | [(THF)NaFe(O^{t}Bu)₃]₂^{e} | 200 | 300 | 72 | 43685 | 1.32 |
| 9 | [(THF)NaFe(O^{t}Bu)₃]₂ | 925 | 420 | 84 | 61500 | 1.49 |
| 10 | [(THF)₄Na₂Fe(OAr)₄] | 210 | 60 | 83 | 25200 | 1.89 |
| 11 | [(THF)₄Na₂Fe(OAr)₄] | 420 | 120 | 52 | 14000 | 2.44 |
| 12 | [(THF)₄Na₂Fe(OAr)₄]^{b} | 380 | 120 | 94 | 1060 | 4.00 |
| 13 | [(THF)₄Na₂Fe(OAr)₄] | 760 | 120 | 84 | 27600 | 2.27 |
| 14 | [(THF)NaFe(O^{t}Bu)₃]₂^{f} | 370 | 30 | 97 | 27700 | 1.87 |
| 15 | [(THF)NaFe(O^{t}Bu)₃]₂^{f} | 600 | 120 | 94 | 23800 | 1.94 |

^{a}Conditions: 10 μmol Fe, 5 mL DCM, ambient temperature;
^{b}1 equiv of EtOH added to run (relative to Fe);
^{c}2 equiv of EtOH added to run;
^{d}3 equiv of EtOH added to run;
^{e}1 equiv of benzoic acid added to run;
^{f}60° C., toluene.

Various modifications and variations of the described methods of the invention will be apparent to those skilled in the art without departing from the scope and spirit of the invention. Although the invention has been described in connection with specific preferred embodiments, various modifications of the described modes for carrying out the invention which are obvious to those skilled in chemistry or related fields are intended to be within the scope of the following claims.

1. Use of a compound of formula I
(L)ₐ(M¹)_{b}(M²)_{c}(X)ₙ I
as a polymerisation initiator, wherein
M¹ is a metal of Group 1, Group 2 or Group 12;
M² is transition metal or a main group metal, and M¹≠M²;
each of b and c is independently 1 or 2;
each X is independently selected from alkoxide (OR¹), thiolate (SR²), amide (NR³R⁴), carboxylate (CO₂R⁵) and acetylacetonate (HC(C(O)R⁶)₂);
each of R¹⁻⁶ is independently a hydrocarbyl group;
n is an integer such that the compound has an overall charge of zero; and
L is absent or is a neutral donor ligand, where a is 1, 2, 3 or 4.

2. Use according to claim 1 wherein each X is independently alkoxide (OR¹) or carboxylate (CO₂R⁵).

3. Use according to claim 1 wherein each of R¹⁻⁶ is independently a C₁-C₂₀ alkyl, a C₂-C₂₀ alkene, a C₆-C₂₀ aryl or a C₂-C₂₀ heteroaromatic group.

4. Use according to claim 3 wherein each of R¹⁻⁶ is independently Et, ^{t}Bu, ⁱPr or 6-di-iso-propylphenyl.

5. Use according to claim 1 wherein said compound is of the formula (L)ₐ(M¹)_{b}(M²)_{d}(OR¹)ₙ.

6. Use according to claim 1 wherein said compound is of the formula (L)ₐ(M¹)_{b}(M²)_{c}(OR¹)_{q}(CO₂R⁵)ᵣ, wherein q and r are integers such that the compound has an overall charge of zero.

7. Use according to any claim 1 wherein b and c are both 1.

8. Use according to claim 1 wherein b is 2 and c is 1.

9. Use according to claim 1 wherein the neutral donor ligand, L, is THF, Et₂O, CH₃CN; pyridine or a crown ether.

10. Use according to claim 1 wherein M¹ is a group 1 metal.

11. Use according to claim 10 wherein M¹ is Na, Li or K.

12. Use according to claim 1 wherein M² is a metal selected from group 4, 5, 12 or 13.

13. Use according to claim 12 wherein M² is Nb, Ti, Al, Ta or Fe.

14. Use according to claim 1 wherein said compound is selected from the following:
{[Na(THF)]⁺[Fe(O^{t}BU)₃]⁻}₂;
([Na(THF)₂]⁺)₂[Fe(OAr)₄]²⁺ where Ar is 2,6-di-iso-propylphenyl;
Na⁺[Ta(OEt)₆]⁻;
Na⁺[Nb(OEt)₆]⁻;
Li⁺[Ti(OⁱPr)₅]⁻;
Na⁺[Ti(OEt)₅]⁻;
Li⁺[Ti(OEt)₅]⁻; and
K⁺[Al(OEt)₄]⁻.

15. Use according to claim 1 in the polymerisation of a lactone.

16. Use according to claim 15 wherein
M¹ is a metal of Group 1;
M² is transition metal;
each X is independently an alkoxide (OR¹); and
L is THF.

17. Use according to claim 16 wherein said compound of formula I is {[Na(THF)]⁺[Fe(O^{t}Bu)₃]⁻}₂ or ([Na(THF)₂]⁺)₂[Fe(OAr)₄]²⁺ where Ar is 2,6-di-iso-propylphenyl.

18. Use according to claim 15 wherein the lactone is lactide or ε-caprolactone.

19. Use according to claim 1 in the polymerisation of an epoxide, wherein said compound of formula I is used in combination with methyl aluminium bis(2,6-di-tert-butyl-4-methylphenoxide).

20. Use according to claim 19 wherein
M¹ is a metal of Group 1;
M² is selected from Nb, Ta, Ti and Al;
each X is independently an alkoxide (OR¹); and
L is absent.

21. Use according to claim 20 wherein
M¹ is selected from Na, K and Li;
M² is selected from Nb, Ta, Ti and Al;
each X is independently selected from OEt, OⁱPr and O^{t}Bu; and
L is absent.

22. Use according to claim 21 wherein said compound of formula I is selected from the following:
Na⁺[Ta(OEt)₆]⁻;
Na⁺[Nb(OEt)₆]⁻;
Li⁺[Ti(OⁱPr)₅]⁻;
Na⁺[Ti(OEt)₅]⁻;
Li⁺[Ti(OEt)₅]⁻; and
K⁺[Al(OEt)₄]⁻.

23. Use according to claim 19 wherein the epoxide is selected from the following:

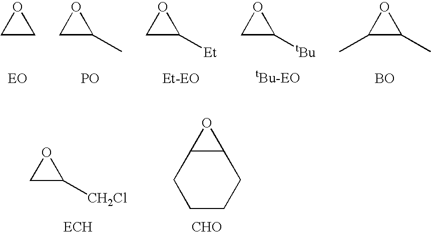

24. A composition comprising a compound of formula I as defined in claim 1, an epoxide, and methyl alummium bis(2,6-di-tert-butyl-4-methylphenoxide).

25. A composition comprising a compound of formula I as defined in claim 1, and a lactone.

26. A composition according to claim 24 which further comprises a solvent.

27. A process for polymerising an epoxide, said method comprising contacting an epoxide with a compound of formula 1 as defined in claim 1 and methyl aluminium bis(2,6-di-tert-butyl-4-methylphenoxide), optionally in the presence of a solvent.

28. A process for polymerising a lactone, said method comprising contacting a lactone with a compound of formula I as defined in claim 1, optionally in the presence of a solvent.

29. A polymer obtainable by a process according to claim 27.

30. A compound of formula [(THF)₄Na₂Fe(OAr)₄].

31. A compound according to claim 30 wherein Ar is 2,6-di-iso-propylphenyl.

32. A compound according to claim 31 which is in crystalline form.

33. A process for preparing a compound according to claim 30, said process comprising:
(i) reacting ArOH with sodium metal in the presence of THF;
(ii) contacting the product of step (i) with FeBr₃ in THF;
(iii) optionally crystallising the product of step (ii).

34. A process according to claim 33 wherein ArOH is 2,6-di-iso-propylphenol.
